(19) United States
(12) Patent Application Publication
(10) Pub. No.: US 2009/0327530 A1
(43) Pub. Date: Dec. 31, 2009

(54) USB DEVICE AND METHOD FOR RECOGNIZING USB MODE OF THE SAME

(75) Inventor: Joon Ho YOUN, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/421,857

(22) Filed: Apr. 10, 2009

(30) Foreign Application Priority Data
Jun. 30, 2008 (KR) 2008-63008

(51) Int. Cl. G06F 3/00

(52) U.S. Cl. 710/14

(57) ABSTRACT

A universal serial bus (USB) device and a method of recognizing a USB mode whereby the USB device automatically recognizes a mass-storage or PictBridge mode according to a type of a connected host such that the USB device configures a communication interface suitable for the recognized host. The USB device includes: a controller to control a USB communication with the host; and an interface unit to automatically determine a mode of the USB communication, from among a plurality of modes, according to a type of the connected host, and to provide a communication interface in the determined mode corresponding to the host. Although the host connected to the USB device does not support several configuration descriptors, a timer of a mass-storage module switches a current mode to the USB mode suitable for a corresponding host, such that the USB device universally supports the USB multi-mode irrespective of host types.

### CROSS-REFERENCE TO RELATED APPLICATION

This application claims the benefit of Korean Patent Application No. 2008-63008, filed Jun. 30, 2008 in the Korean Intellectual Property Office, the disclosure of which is incorporated herein by reference.

### BACKGROUND OF THE INVENTION

1. Field of the Invention

Aspects of the present invention relate to a universal serial bus (USB) device that automatically recognizes and/or supports a USB multi-mode according to categories of a host connected to a device supporting a USB communication operation via a USB, and a method of recognizing a mode of the USB device.

2. Description of the Related Art

Generally, a USB is used as an interface specification of personal computer (PC) peripheral devices developed by Intel, Microsoft, Compaq, IBM, DEC, NEC, and Nortel Corporations. A host (e.g., a computer or a printer) is connected to the device (e.g., a digital camera, or a camcorder), which may store image data and supports a USB communication operation, via a USB cable. Accordingly, a communication operation to transmit data stored in the device to the host is carried out.

The USB communication operation may include a mass-storage class mode and a PictBridge mode. The mass-storage class mode connects the computer to the USB device via the USB cable, records data in an inner mass-storage memory, and performs data communication. The PictBridge mode directly connects the USB device to the printer via the USB cable without using the computer, such that a direction print operation (hereinafter referred to as a PictBridge) is carried out. Generally, an image device supports both a mass-storage mode and a PictBridge mode.

The USB device capable of supporting the mass-storage mode and the PictBridge mode has been disclosed in Japanese Patent Laid-open No. 2002-305677, the disclosure of which is hereby incorporated by reference. The USB device disclosed in Japanese Patent Laid-open No. 2002-305677 determines whether a host connected to the USB device is a computer or a printer via a USB cable, and allows a user to selects a mass-storage mode or a PictBridge mode accordingly. As a result, the USB device transmits data according to a communication specification of the corresponding host.

However, in the case of the above-mentioned conventional USB device, the user must manually select the mass-storage mode or the PictBridge mode according to the type of a host connected to the USB cable, resulting in greater inconvenience of use. A USB device capable of solving the above-mentioned problem, though, is disclosed in Japanese Patent Laid-open No. 2006-113768, the disclosure of which is hereby incorporated by reference. When an initialization process is carried out by a host connected to the USB device, USB mode information (i.e., two configuration descriptors) of the device is transmitted from the device. Accordingly, the USB device informs the host that the USB device can simultaneously support the mass-storage mode and the PictBridge mode. The host selects a desired mode, such that data is transmitted according to a communication specification suitable for the corresponding host.

However, according to the above-mentioned Japanese Patent Laid-open No. 2006-113768, the printer connected to the USB device must support several configuration descriptors to automatically recognize the mass-storage mode and the PictBridge mode. However, if the printer is incapable of supporting the several configuration descriptors is connected to the USB device, the USB device cannot automatically connect to the PictBridge mode, such that the user must manually select a desired mode, resulting in greater inconvenience of use.

### SUMMARY OF THE INVENTION

Aspects of the present invention provide a USB device that automatically recognizes a mass-storage mode or a PictBridge mode according to a type of a host connected to the USB device, such that the USB device configures a communication interface suitable for the recognized host, and a method of recognizing a mode of the USB device.

According to an aspect of the present invention, there is provided a universal serial bus (USB) apparatus connected to a host, the USB apparatus including: a controller to control a USB communication with the host; and an interface unit to automatically determine a mode of the USB communication, from among a plurality of modes, according to a type of the connected host, and to provide a communication interface for the determined mode corresponding to the host.

According to an aspect of the present invention, the USB apparatus may be a digital camera, a camcorder, or a mobile communication terminal.

According to an aspect of the present invention, the plurality of modes of the USB communication may include a mass-storage mode and/or a PictBridge mode.

According to an aspect of the present invention, if the host is a computer, the interface unit may determine the mode to be the mass-storage mode.

According to an aspect of the present invention, if the host is a printer, the interface unit may determine the mode to be the PictBridge mode.

According to an aspect of the present invention, the interface unit may include: a first communication module to perform a communication operation in the mass-storage mode; and a second communication module to perform a communication operation in the PictBridge mode.

According to an aspect of the present invention, the interface unit may operate the first or the second communication module during an initialization process carried out by the host connected to the device, such that the mass-storage mode or the PictBridge mode is operated as a default.

According to an aspect of the present invention, the first or the second communication modules may include a timer operated for the initialization process under the mass-storage mode or the PictBridge mode.

According to another aspect of the present invention, there is provided a method of recognizing a mode of a universal serial bus (USB) apparatus connected to a host, the method including: performing an initialization process when the USB apparatus is connected to the host; and determining, by the USB apparatus, the mode of a USB communication with the host, from among a plurality of modes, according to a type of the connected host during the initialization process, and providing a communication interface for the determined mode corresponding to the host.

According to an aspect of the present invention, the plurality of modes of the USB communication may include a mass-storage mode and a PictBridge mode.

According to an aspect of the present invention, the determining of the mode may include: operating in the mass-storage mode as a default during the initialization process performed by the host connected to the USB apparatus.

According to an aspect of the present invention, the method determining of the mode may further include: performing the initialization process, in the mass-storage mode, for a predetermined period of time after the USB apparatus is connected to the host.

According to an aspect of the present invention, the determining of the mode may further include: upon receiving a response signal from the host within the predetermined period of time, determining the mass-storage mode as the mode of the USB communication with the host.

According to an aspect of the present invention, the determining of the mode may further include: upon receiving no response signal from the host within the predetermined period of time, stopping the operation in the mass-storage mode, and determining the PictBridge mode as the mode of the USB communication with the host.

According to an aspect of the present invention, the determining of the mode may include: operating in the PictBridge mode as a default during the initialization process performed by the host connected to the USB apparatus.

According to an aspect of the present invention, the determining of the mode may further include: performing the initialization process, in the PictBridge mode, for a predetermined period of time after the USB apparatus is connected to the host.

According to an aspect of the present invention, the determining of the mode may further include: upon receiving a response signal from the host within the predetermined period of time, determining the PictBridge mode as the mode of the USB communication with the host.

According to an aspect of the present invention, the determining of the mode may further include: upon receiving no response signal from the host within the predetermined period of time, stopping the operation in the PictBridge mode, and determining the mass-storage mode as the mode of the USB communication with the host.

According to yet another aspect of the present invention, there is provided a universal serial bus (USB) system including: a host to communicate through a USB connection; and a USB apparatus connected to the host, the USB apparatus including: a controller to control a USB communication with the host, and an interface unit to automatically determine a mode of the USB communication, from among a plurality of modes, according to a type of the connected host detected by a response of the connected host while operating in one of the modes, and to provide a communication interface for the determined mode corresponding to the host.

According to another aspect of the present invention, there is provided a method of operating a host connected to a universal serial bus (USB) apparatus, the method including: transmitting, by the host, a response signal to the connected USB device, such that the connected USB device receives the response signal when operating in a mode of USB communication corresponding to a type of the host, from among a plurality of modes, and the response signal is responsive to communication in the mode; and transmitting data with respect to the USB device according to the mode of USB communication, wherein the USB device successively operates in one or more of the plurality of modes until the USB device receives the response signal to determine the mode of the USB communication corresponding to the type of the host.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a structural diagram illustrating a USB system according to an embodiment of the present invention;

FIG. 2 is a block diagram illustrating a USB device according to an embodiment of the present invention;

FIG. 3 is a flow chart illustrating a mode recognition method of a USB device according to an embodiment of the present invention; and

FIG. 4 shows an example of initialization data of a mass-storage mode enabled when a printer is connected to a USB device according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below to explain the present invention by referring to the figures.

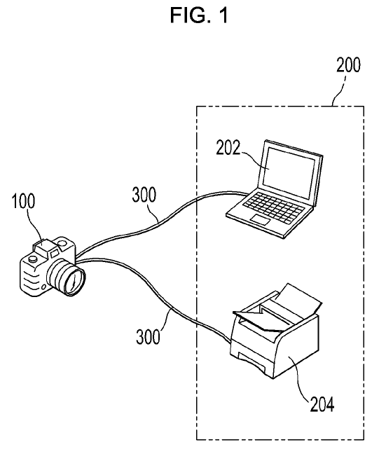

FIG. 1 is a structural diagram illustrating a universal serial bus (USB) system according to an embodiment of the present invention. Referring to FIG. 1, the USB system includes a device 100 to provide image files based on a USB communication, and a host 200 connected to the device 100 via a USB cable 300, such that the host 200 receives the image files from the device 100. In detail, the device 100 is a general device (for example, a digital camera, a camcorder, a mobile communication terminal, a storage unit, etc.) that stores image files and supports a USB communication operation. The host 200 is a general host (for example, a computer 202 or a printer 204) that is connected to the device 100 via the USB cable 300. While not limited thereto, the USB communication can be according to USB 1.0, 2.0, or 3.0, but is not limited thereto.

The USB system of FIG. 1 uses the digital camera as the device 100, and uses the computer 202 or the printer 204 as an example of the host 200 connected to the device 100. However, it is understood that aspects of the present invention are not limited thereto. For example, the device 100 may be a camcorder, a mobile communication terminal, or any USB storage unit that stores image files.

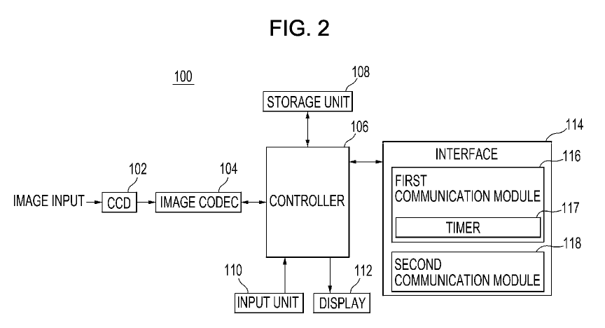

FIG. 2 is a block diagram illustrating a USB device 100 according to an embodiment of the present invention. Referring to FIG. 2, the device 100 is a mobile-type image apparatus that stores image files and supports a mass-storage mode and a PictBridge mode from among a USB communication operation. The device 100 includes a camera module 102, an image codec 104, a controller 106, a storage unit 108, an input unit 110, a display 112, and an interface unit 114.

The camera module 102 captures external-input images, and transmits the image signals to the image codec 104. The image codec 104 compresses and/or encodes image signals received from the camera module 102 (for example, according to a JPEG format), and generates image data. Moreover, the image codec 104 may decode the encoded image data, and convert the encoded image data into the image signals.

The controller 106 controls overall operations of the device 100. Specifically, the controller 106 stores the external-input images in the storage unit 108, reproduces image files stored in the storage unit 108, and controls a file transfer operation between the device 100 and the host 200. Moreover, according to aspects of the present invention, the controller 106 automatically recognizes a mass-storage mode or a PictBridge mode according to a type (for example, a computer or a printer) of a host 200 connected to the device 100, such that the controller 106 constructs a communication interface suitable for a corresponding host 200. In other words, the controller 106 constructs the USB communication interface suitable for the corresponding host 200, though a user does not select the USB mode using the input unit 110. For example, when the device 100 is connected to the computer 202 during the initialization process performed by the device 100 connected to the host 200, the mass-storage mode is carried out as a default for a predetermined period of time. If a response signal (i.e., a mass-storage command) is received from the host 200, a communication interface between the device 100 and the host 200 is configured under a mass-storage mode, such that a communication operation between the device 100 and the host 200 is carried out. If the host 200 does not transmit the response signal (i.e., the mass-storage command) during the predetermined period of time, a current mode is switched to a PictBridge mode, such that the initialization process is re-performed under the PictBridge mode. The communication interface between the device 100 and the host 200 is configured under the PictBridge mode, such that the communication operation between the device 100 and the host 200 is carried out.

The storage unit 108 may be external or internal, and may be a volatile memory (such as RAM) or a non-volatile memory (such as ROM, a memory card, flash memory, a flash-type EEPROM, or a hard disk drive). The input unit 110 is a User Interface (UI) to allow a user to enter a command, such that the user selects or reproduces a desired image file via the User Interface (UI), and commands the device 100 to transmit a user-desired image file to the host 200. The display 112 displays a communication interface confirmation message on a setup screen using the User Interface (UI) when the device 100 is connected to the host 200 by a control signal generated by the controller 106.

The interface unit 114 configures a communication interface between the device 100 and the host 200 by a control signal generated from the controller 106. The interface unit 114 includes a first communication module 116 (for example, a mass storage module) to perform a communication operation under a first mode (for example, a mass storage mode) and a second communication module 118 (for example, a PictBridge module) to perform a communication operation under a second mode (for example, a PictBridge mode).

If the host 200 connected to the device 100 is a computer 202, the first communication module 116 performs the communication operation of the mass-storage mode between the device 100 and the host 200. The first communication module 116 includes a timer 117 operated for an initialization process of the mass-storage mode. Specifically, when an initialization process is carried out by a connection between the device 100 and the host 200, the mass-storage mode is carried out as a default for a predetermined period of time (e.g., 1 second). The first communication module 116 stores a program to control and/or to manage a communication of the mass-storage mode.

Conversely, if the host 200 connected to the device 100 is a printer 204, the second communication module 118 performs the communication operation of the PictBridge mode between the device 100 and the host 200. Specifically, if the first communication module 116 fails to connect to the mass-storage mode performed as a default for the predetermined period of time when the initialization process is performed by a connection between the device 100 and the host 200, the second communication module 118 re-performs the initialization process associated with the host 200 using a USB communication switched to the PictBridge mode. Furthermore, the second communication module 118 stores a program to control and/or to manage a PictBridge-mode communication.

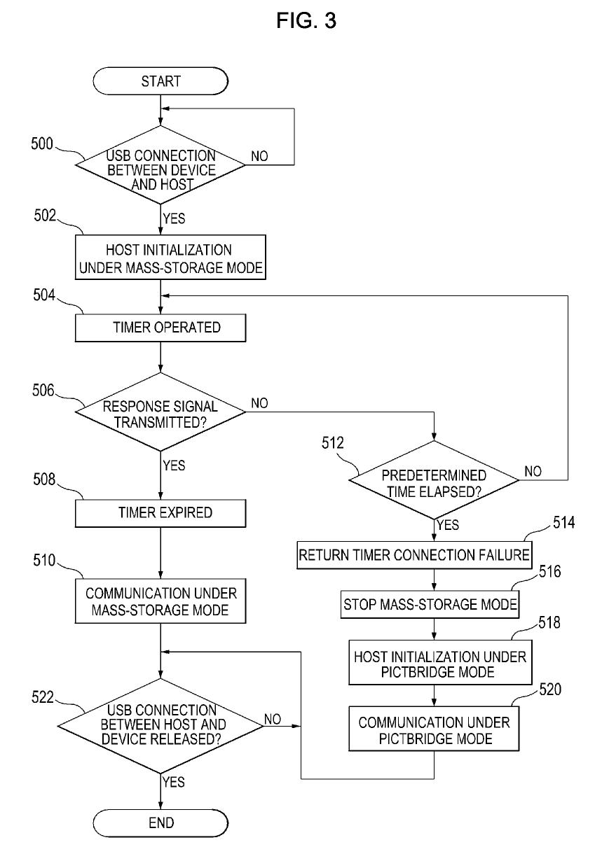

The above-mentioned USB device 100 and a method of recognizing a mode of the USB device 100 according to an embodiment of the present invention will hereinafter be described in detail with reference to FIG. 3. As described above, the USB device 100 captures external-input images using the camera module 102, and transmits image signals to the image codec 104. The image codec 104 compresses and/or encodes the image signals received from the camera module 102, generates the encoded image files, and stores the generated image files (for example, JPEG files) in the storage unit 108. A digital camera may be used as the USB device 100, though aspects of the present invention are not limited thereto.

FIG. 3 is a flow chart illustrating a mode recognition method of a USB device 100 according to an embodiment of the present invention. Referring to FIG. 3, if the device 100 (e.g., a digital camera) is connected to the host 200 (e.g., a computer 202 or a printer 204) via the USB cable 300 at operation 500, the device 100 is unable to recognize whether the connected host 200 is the host 202 or the printer 204. Accordingly, the first communication module 116 is operated as a default, such that the initialization process associated with the host 200 is carried out under the mass-storage mode in operation 502.

When the host 200 begins to perform the initialization process (operation 502), the timer 117 of the first communication module 116 is operated for a predetermined period of time at operation 504. Generally, the initialization process performed by the connection between the device 100 and the host 200 is completed within 0.6 seconds at full or high speed, such that the predetermined time established by the timer 117 may be 1 second. However, it is understood that aspects of the present invention are not limited thereto, and the predetermined time may vary or may be less than or greater than 1 second.

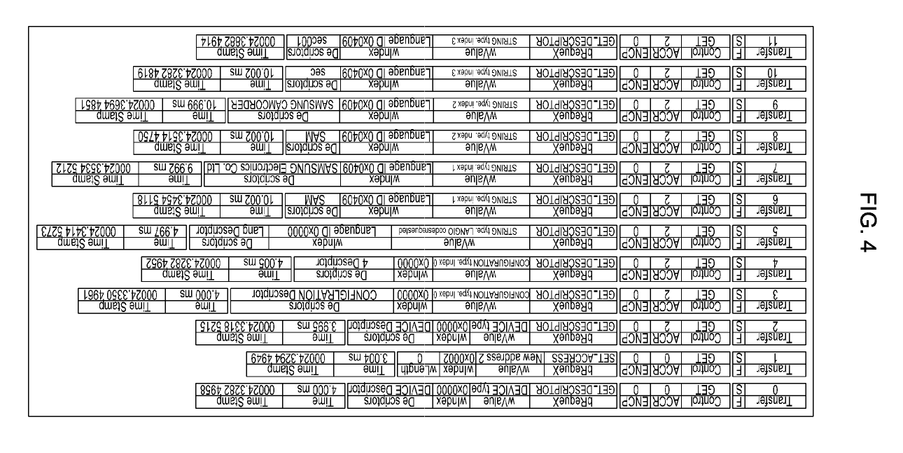

If the computer 202 is connected to the device 100, the computer 202 transmits a response signal after the initialization process is completed under the mass-storage mode. However, if the printer 204 is connected to the device 100, the printer 204 transmits no response signals as shown in FIG. 4 after the initialization process is completed under the mass-storage mode. As a result, the device 100 determines whether the response signal (i.e., the mass-storage command) is transmitted from the host 200 in operation 506, such that the device 100 is able to recognize the type of the connected host 200.

If the device 100 determines that the response signal has been transmitted from the host 200 (operation 506), the computer 202 that communicates with the device 100 under the mass-storage mode is connected to the device 100. Accordingly, the device 100 stops operation of the timer 117 or the timer expires in operation 508. Therefore, if the device 100 receives the response signal from the host 200, the device 100 continuously performs a communication operation under the mass-storage mode in operation 510 without reattempting to connect to the host 200.

In the meantime, if the device 100 does not receive a response signal from the host 200 (operation 506), the device 100 determines whether the predetermined period of time has elapsed in operation 512. If the predetermined period of time has not elapsed (operation 512), the device 100 returns to operation 504. Accordingly, the device 100 continuously checks whether the host 200 transmits the response signal until the predetermined period of time elapses in operation 512. If the predetermined period of time elapses (operation 512), the device 100 returns the failure of a connection to the host 200 in operation 514, stops operation of the first communication module 116, and stops the communication in the mass-storage mode in operation 516. Then, the device 100 operates the second communication module 118, such that the initialization process associated with the host 200 is re-performed under the PictBridge mode at operation 518. After the initialization process has been completed (operation 518), the communication operation is carried out under the PictBridge mode at operation 520. Thereafter, if the USB connection between the device 100 and the host 200 is released at operation 522, a communication operation of the mass-storage mode or the PictBridge mode according to the host 200 connected to the device 100 is completed.

According to the above-mentioned embodiment, the first communication module 116 is firstly operated during the initialization process performed by the host 200 connected to the device 100, the mass-storage mode is carried out as a default, and a communication operation is carried out under the mass-storage mode or the PictBridge mode upon receiving a response signal from the host 200. However, it is understood that aspects of the present invention are not limited to only the above-mentioned embodiment. For example, according to other aspects, the second communication module 118 may be operated first instead of the first communication module 116, such that the PictBridge mode is carried out as a default. In this case, the timer 117 may be included in the second communication module 118, rather than the first communication module 116, or an additional timer may be added as necessary. Furthermore, according to other aspects, different and/or additional communication modes may be implemented. For example, the device 100 may include a third communication module such that if response signals are not respectively transmitted during a host initialization in the mass-storage mode and a host initialization in the PictBridge mode, the third communication module controls and/or manages an initialization in a third mode. Moreover, other communication modes, instead of the mass-storage mode and/or the PictBridge mode, may be implemented.

As is apparent from the above description, the USB device 100 and a mode recognition method thereof according to aspects of the present invention automatically recognizes a mass-storage mode or a PictBridge mode according to a type of a host connected to a USB device, such that a communication interface suitable for a corresponding host 200 can be configured. Although the host 200 connected to the USB device 100 may not support several configuration descriptors, the USB device 100 switches to the USB mode suitable for a corresponding host 200 by a timer contained in a mass-storage module, such that the device 100 can support a USB multi-mode irrespective of the host type.

While not restricted thereto, aspects of the present invention can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A universal serial bus (USB) apparatus connected to a host, the USB apparatus comprising:
a controller to control a USB communication with the host; and
an interface unit to automatically determine a mode of the USB communication, from among a plurality of modes, according to a type of the connected host, and to provide a communication interface for the determined mode corresponding to the host.

2. The USB apparatus as claimed in claim 1, wherein the USB apparatus is a digital camera, a camcorder, or a mobile communication terminal.

3. The USB apparatus as claimed in claim 1, wherein the plurality of modes of the USB communication includes a mass-storage mode and/or a PictBridge mode.

4. The USB apparatus as claimed in claim 3, wherein:
if the host is a computer, the interface unit determines the mode to be the mass-storage mode, and provides the communication interface in the mass-storage mode.

5. The USB apparatus as claimed in claim 3, wherein:
if the host is a printer, the interface unit determines the mode to be the PictBridge mode and provides the communication interface in the PictBridge mode.

6. The USB apparatus as claimed in claim 3, wherein the interface unit comprises:
a first communication module to perform a communication operation in the mass-storage mode; and
a second communication module to perform a communication operation in the PictBridge mode.

7. The USB apparatus as claimed in claim 6, wherein the interface unit operates the first communication module or the second communication module during an initialization process carried out by the host connected to the device, such that the mass-storage mode or the PictBridge mode is operated as a default.

8. The USB apparatus as claimed in claim 7, wherein the first communication module or the second communication module comprises a timer operated for the initialization process under the mass-storage mode or the PictBridge mode.

9. The USB apparatus as claimed in claim 1, wherein the interface unit comprises:
a first communication module to perform a communication operation in a first mode, of the plurality of modes; and
a second communication module to perform a communication operation in a second mode, of the plurality of modes.

10. The USB apparatus as claimed in claim 9, wherein the first mode is a default initialization mode such that the first communication module operates as a default when the USB apparatus is connected to the host.

11. The USB apparatus as claimed in claim 10, wherein, if the first communication module does not receive a signal from the host responsive to communication in the first mode for a predetermined period of time after the USB apparatus is connected to the host, the interface unit determines the second mode to be the mode of the USB communication and the second communication module performs the communication operation in the second mode.

12. The USB apparatus as claimed in claim 11, wherein the first mode is a mass-storage mode and the second mode is a PictBridge mode.

13. A method of recognizing a mode of a universal serial bus (USB) apparatus connected to a host, the method comprising:
performing an initialization process when the USB apparatus is connected to the host; and
determining, by the USB apparatus, the mode of a USB communication with the host, from among a plurality of modes, according to a type of the connected host during the initialization process, and providing a communication interface for the determined mode corresponding to the host.

14. The method as claimed in claim 13, wherein the plurality of modes of the USB communication includes a mass-storage mode and/or a PictBridge mode.

15. The method as claimed in claim 14, wherein the determining of the mode comprises:
operating in the mass-storage mode as a default during the initialization process performed by the host connected to the USB apparatus.

16. The method as claimed in claim 15, wherein the determining of the mode further comprises:
performing the initialization process, in the mass-storage mode, for a predetermined period of time after the USB apparatus is connected to the host.

17. The method as claimed in claim 16, wherein the determining of the mode further comprises:
upon receiving a response signal from the host within the predetermined period of time, determining the mass-storage mode as the mode of the USB communication with the host.

18. The method as claimed in claim 16, wherein the determining of the mode further comprises:
upon receiving no response signal from the host within the predetermined period of time, stopping the operation in the mass-storage mode, and determining the PictBridge mode as the mode of the USB communication with the host.

19. The method as claimed in claim 14, wherein the determining of the mode comprises:
operating in the PictBridge mode as a default during the initialization process performed by the host connected to the USB apparatus.

20. The method as claimed in claim 19, wherein the determining of the mode further comprises:
performing the initialization process, in the PictBridge mode, for a predetermined period of time after the USB apparatus is connected to the host.

21. The method as claimed in claim 20, wherein the determining of the mode further comprises:
upon receiving a response signal from the host within the predetermined period of time, determining the PictBridge mode as the mode of the USB communication with the host.

22. The method as claimed in claim 20, further comprising:
upon receiving no response signal from the host within the predetermined period of time, stopping the operation in the PictBridge mode and determining the mass-storage mode as the mode of the USB communication with the host.

23. The method as claimed in claim 14, wherein the determining of the mode comprises:
determining the mode of the USB communication with the host to be the mass-storage mode if the host is a computer; and
determining the mode of the USB communication with the host to be the PictBridge mode if the host is a printer.

24. The method as claimed in claim 13, wherein the determining of the mode comprises:
operating in a first mode, of the plurality of modes, when the USB apparatus is connected to the host;
determining the first mode as the mode of the USB communication with the host if a response signal responsive to communication in the first mode is received from the host within a predetermined period of time while operating in the first mode; and
determining a second mode, of the plurality of modes, as the mode of the USB communication with the host if the response signal is not received from the host within the predetermined period of time while operating in the first mode.

25. The method as claimed in claim 24, wherein the determining of the second mode as the mode of the USB communication comprises:
operating in the second mode if the response signal responsive to the communication in the first mode is not received from the host within the predetermined period of time while operating in the first mode;
determining the second mode as the mode of the USB communication with the host if the response signal responsive to communication in the second mode is received from the host within a predetermined period of time while operating in the second mode; and
determining that the second mode is not the mode of the USB communication with the host if the response signal responsive to the communication in the second mode is not received from the host within the predetermined period of time while operating in the second mode.

26. A computer-readable recording medium encoded with the method of claim 13 and implemented by at least one computer.

27. A universal serial bus (USB) system comprising:
a host to communicate through a USB connection; and
a USB apparatus connected to the host, the USB apparatus comprising:
a controller to control a USB communication with the host, and
an interface unit to automatically determine a mode of the USB communication, from among a plurality of modes, according to a type of the connected host detected by a response of the connected host while operating in one of the modes, and to provide a communication interface for the determined mode corresponding to the host.

28. A method of operating a host connected to a universal serial bus (USB) apparatus, the method comprising:
transmitting, by the host, a response signal to the connected USB device, such that the connected USB device receives the response signal when operating in a mode of USB communication corresponding to a type of the host, from among a plurality of modes, and the response signal is responsive to communication in the mode; and
transmitting data with respect to the USB device according to the mode of USB communication,
wherein the USB device successively operates in one or more of the plurality of modes until the USB device receives the response signal to determine the mode of the USB communication corresponding to the type of the host.

29. A computer-readable recording medium encoded with the method of claim 28 and implemented by at least one computer.
